(19) United States
(12) Patent Application Publication
(10) Pub. No.: US 2007/0245250 A1
(43) Pub. Date: Oct. 18, 2007

(54) Desktop window manager using an advanced user interface construction framework

(75) Inventors: Greg D. Schechter, Seattle, WA (US); Adrian Secchia, Bellevue, WA (US); Andrey E. Arsov, Sammamish, WA (US); Jeffrey L. Bogdan, Bellevue, WA (US); Jevan D. Saks, Redmond, WA (US)

Correspondence Address: MICROSOFT CORPORATION, ONE MICROSOFT WAY, REDMOND, WA, 98052-6399, US

(73) Assignee: Microsoft Corporation Microsoft Patent Group, Redmond, WA (US)

(21) Appl. No.: 11/406,018

(22) Filed: Apr. 18, 2006

(51) Int. Cl. G06F 17/00

(52) U.S. Cl. 715/760

(57) ABSTRACT

An operating system's desktop window manager uses a presentation framework that enables many different visual effects and standardized mechanisms for graphic presentation, including data binding. The presentation framework may be available through a markup language for the desktop window manager as well as applications on the computer desktop. The presentation framework may enable animations, themes, styles, 3D functionality, or other complex graphical features to be applied to the application windows by the desktop window manager as well as for the client areas controlled by the applications. By using a presentation framework with functionality adapted for general computer applications, many advanced functions may be applied to desktop windows without low level programming.

### BACKGROUND

The computer desktop is an evolving entity, with a user's graphical interface becoming more and more complex and interactive. Multiple applications may be operating simultaneously and may interface with the user through movable windows, icons, toolbars, menus, or other areas of the screen.

In some operating systems, a markup language may be used to define the behavior of objects displayed by a computer application. One such example is XAML, or eXtensible Application Markup Language. XAML may be used by application designers to easily create many different graphical devices on a screen. Application developers may use a computer programming language, such as C#, Visual Basic, Java, or any other programming language to generate the functional code of the computer application. By using a markup language for a portion of the user interface description, an application designer may control the look and feel of an application separate from the functional aspects that may be handled by a programmer or developer.

XAML or a similar system may be used for controlling the user interface of a computer application. However, in a typical operating system, the graphical display and controls are performed using low level graphics functionality available in the operating system.

### SUMMARY

An operating system's desktop window manager uses a presentation framework that enables many different visual effects and standardized mechanisms for graphic presentation, including data binding. The presentation framework may be available through a markup language for the desktop window manager as well as being made available to applications on the computer desktop. The presentation framework may enable animations, themes, styles, 3D functionality, or other complex graphical features to be applied to the application windows by the desktop window manager as well as for the client areas controlled by the applications. By using a presentation framework with functionality adapted for general computer applications, many advanced functions may be applied to desktop windows without low level programming.

### BRIEF DESCRIPTION OF THE DRAWINGS

In the drawings,

FIG. 1 is a diagrammatic illustration of an embodiment showing a user interface system that uses a common presentation framework for applications and the desktop window manager.

FIG. 2 is a diagrammatic illustration of an embodiment showing a user display with several windows created using a presentation framework.

FIG. 3 is a diagrammatic illustration of an embodiment showing a computer system that uses a software architecture that comprises a presentation framework.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

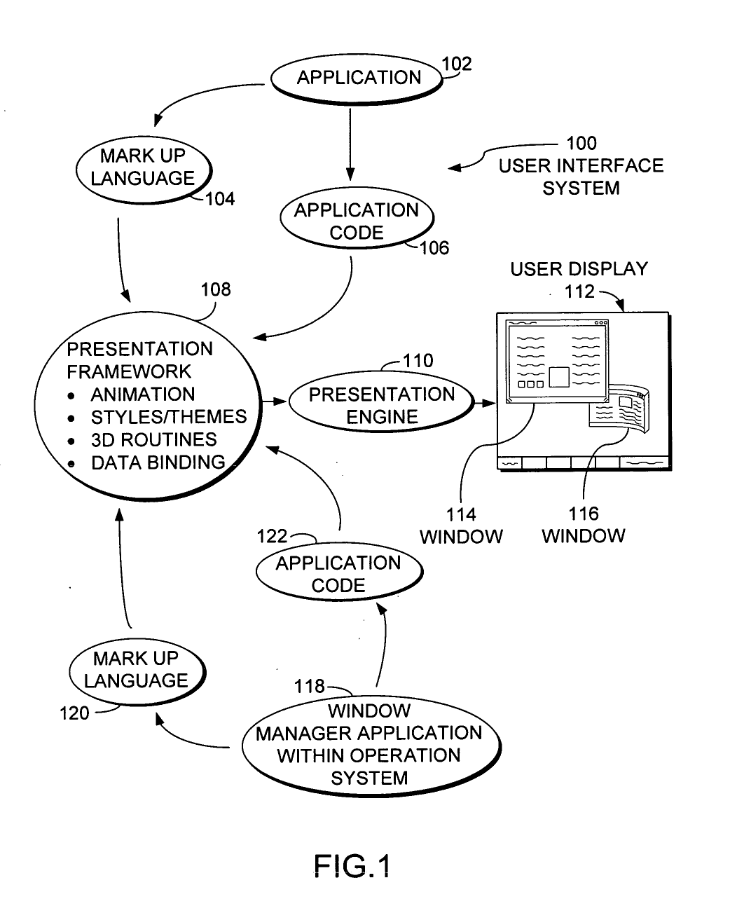

FIG. 1 is a pictorial representation of an embodiment 100 showing a user interface system. An application 102 may use a markup language 104 or conventional programming code 106 to engage a presentation framework 108. The presentation framework 108 provides much of the input to a presentation engine 110 that generates the image presented to a user on a user display 112. One or more applications 102 may generate the content displayed on the windows 114 and 116.

Similarly, the window manager application 118 within the operating system may use a markup language 120 or conventional programming code 122 to access the presentation framework 108. The window manager application 118 may control the non-client area of the windows 114 and 116 through the presentation engine.

The embodiment 100 applies the functionality in the presentation framework 108 to both the client and non-client areas of the user display 112. The client areas are those controlled by the application 102, while the non-client areas are those controlled by the window application manager 118. The window application manager 118 may control the presentation of the window on the computer desktop, including placement, sizing, and control of the window as a whole. The application 102 may control the entire contents of the window, including all data and presentation of data within the window.

The embodiment 100 uses a presentation framework 108 that contains functionality to perform animation, apply styles and themes, three dimensional effects, data binding, and other functionality. The presentation framework 108 may be developed for applications to present data, layout the client area, and perform advanced functions within the client area of a user interface. In some instances, the application 102 or the desktop window manager 118 may create graphic images using low level code and bypass the presentation framework.

The presentation framework 108 may consist of many classes that describe groups of encapsulated instance variables and methods. For example, one class within the presentation framework 108 may be devoted to text presentation and manipulation, while another class may comprise animation functions. The configuration and organization of the classes may vary from one embodiment to another.

These advanced functions may be applied to the presentation of the application windows as a whole, when the window manager application within the operating system 118 uses the same presentation framework. This may allow the non-client areas of the windows to be described using the presentation framework. It is possible to create all visual effects through hard coding each effect using primitives within the operating system. However, by using a shared presentation framework, the developer of the operating system interface may leverage shared functionality that may otherwise be too difficult or expensive to recreate within the operating system.

Further, the presentation framework may enable the development of the operating system interface to be split between designers who focus on the layout and look and feel of the interface with the program coders or developers who create the functionality of the application. The designers may create markup language code that defines the look and feel variables of the interface, while the developers may use traditional programming languages to create the functional aspects. In some applications, the presentation framework may be invoked through traditional programming languages exclusively, or in combination with a markup language. In other applications, the presentation framework may be invoked through the markup language alone.

The markup language may be any type of markup language that may define attributes that can be used with the presentation framework. One such markup language is XAML, or eXtensible Application Markup Language. XAML may be used for creating and controlling various elements and attributes that are visually displayed. Additionally, XAML may be used for data binding and for many different 3D and 2D effects.

The presentation engine 110 may generate the visual image shown on the user display 112. In some embodiments, the presentation engine 110 may take all the display actions defined by the various applications 102 and the window manager application 118 and create the windows 114 and 116, the content in the windows, and the general layout of the user interface. The presentation engine 110 may operate in real time, keeping the user interface refreshed as the user interacts with the computer and the applications are functioning. The presentation engine 110 may be an operating system level application, while in other implementations, the presentation engine 110 may be a higher level application.

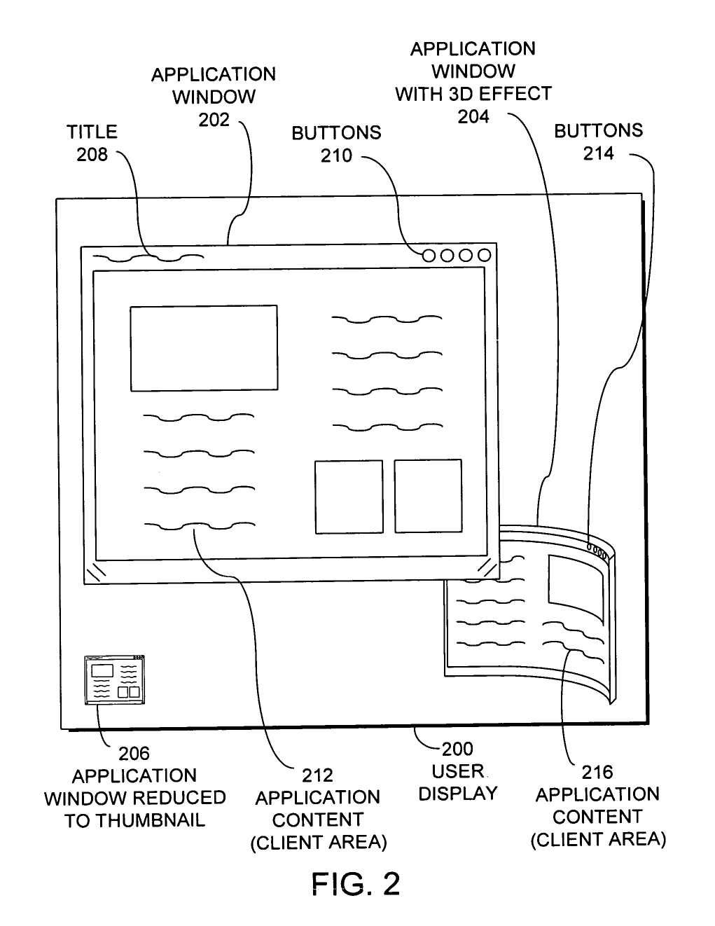

FIG. 2 is a pictorial illustration of an embodiment 200 of a user display. Application window 202 is shown open and on top of the desktop environment. Application window 204 has a three dimensional effect and is placed behind window 202. Application window 206 is reduced to a thumbnail image.

Application window 202 has a title 208 and some buttons 210 and application client area 212. Similarly, application window 204 has buttons 214 and application client area 216.

In general, the application windows may be divided into two portions: the client areas 212 and 216, and the non-client areas that may include the borders, button 210 and 214 and the title 208. The applications operating on the computer system may provide and control all of the content in the client areas, while the desktop window manager application may define and control the non-client areas. Additionally, the desktop window manager application may control the positioning, appearance, and presentation of the windows themselves.

For example, the window manager application may control the appearance of each window, applying the curved three dimensional effect of window 204 or the thumbnail view of window 206. Even though a window may not be highlighted, the application that supports the window may be operational and the content area of the window may be continuously updated by the application.

The applications may make use of a generalized presentation framework for presenting the final image to the user on the application window. The presentation framework may be developed to make use of advanced hardware configurations such as high speed graphics accelerator cards or may be adaptable across different types of applications, such as web-based applications viewed through a browser or stand alone applications that are viewed through dedicated application windows. By using the presentation framework, a developer's application may be portable across different hardware configurations or even delivery methods of the application.

In some embodiments, the presentation framework may use vector driven graphics as opposed to bitmapped graphics. When vector driven graphics are used, the presentation may be readily scaled to different screen resolutions. For example, a very high density screen may take many more pixels to generate the same physical size image than the same image displayed on a low density screen. Such a change of resolution is much easier when the presentation framework uses vector-based graphics.

Such a presentation framework may have many routines and functions that can be used by applications. Such functions may include basic controls, image and text manipulation, animation, three dimensional routines, data binding, styles and themes, and other functions. Basic controls may include routines for generating various buttons, input boxes, hot spots, or other areas on a display where the user may interact with the application.

The presentation framework may also include the ability to manipulate graphics, apply colors and textures to the screen, apply transparency functions, overlay different graphic images, position graphics, or other functions to create various images. The graphics manipulation may also include creating ‘brushes’ or other functions for transforming images. Such transformations may include mirroring, stretching, rotating, or mapping the image to a surface, among others. Additionally, the presentation framework may include text manipulation and presentation functions, including font selection, applying colors and textures to fonts, using glyphs and special characters for certain fonts, placing the text in various positions, stretching or sizing the text, or other functions.

Animation routines may be present in the presentation framework. Animation routines may include creating movies of several images played back in succession, moving an object across the screen from one place to another, transforming an object from one image to another, smoothly zooming in and out on an object, or any other animation routine that can be imagined.

Three dimensional routines may also be available in the presentation framework. An object may be defined in three dimensions and have lighting, camera positions, viewpoints, and other parameters defined to create a three dimensional representation of the object on the two dimensional screen. In some embodiments, the objects may be rotated or translated on the screen and the screen image may be updated in real time.

Data binding may be provided through the presentation framework. By associating or binding the value of one variable to the input of a function or other variable, a change in the first variable may cause a change in the second variable or function. For example, if the vertical height of a bar displayed on the screen was bound to the output of a thermometer reading, a rise in temperature should cause the vertical height of the bar to increase. Within the presentation framework, disparate variables such as these may be associated with each other through data binding. When such data are bound, a presentation engine that uses the presentation framework may be able to associate the two bound variables and keep them continually updated. Data binding is an advanced feature of some high level programming languages.

Because the presentation framework may contain many variables for the creation and manipulation of application displays, the presentation framework may be adapted to create styles or themes that may be common across a set of objects. For example, a certain application may have a specific ‘look and feel’ defined by the fonts, color palette, and positioning of the elements on the screen. The application designer may define a common set of variables that encapsulate the ‘look and feel’ of the application, and apply those variables to all or a subset of the objects displayed by that application. Style sheets and similar technologies are commonly used in HTML coding.

The presentation framework may provide an enormously powerful and flexible tool for application developers who wish to take advantage of the portability, adaptability, and simplicity of their code when they use presentation framework for developing their application.

Such a presentation framework may be made a part of the operating system distribution and therefore be available to the operating system level applications such as the desktop window manager.

The desktop window manager may use many of the features of the presentation framework for defining and manipulating the various windows on the desktop. In many respects, the traditional approach for window manager applications was to write the functions to define and manipulate application windows using low level programming techniques. For example, buttons or text on a non-client area of a window may be created using the low level functionality available within the operating system.

In the present embodiment, the desktop window manager may use a presentation framework developed for and used by applications for graphics creation. By using a very broad and powerful presentation framework, the desktop window manager may take advantage of very powerful functionality that would be otherwise costly and difficult to recreate in low level programming within the operating system.

For example, the desktop window manager may use the button and control creation functionality of the presentation framework to define the buttons 210 and 214 on the windows. Because the buttons may be defined using the presentation framework, the designer of the window manager may use all the power and flexibility of the presentation framework, including building the graphics and text functions to build a button with advanced graphics or text features without the detailed programming if the operating system primitives were used.

Similarly, the window as a whole may be created and manipulated using the advanced features of a presentation framework. For example, three dimensional effects may be applied to the window as a whole, such as with window 204, which is given a thickness and mapped to a curved surface. When the three dimensional transformation is applied to the entire window, the application client area 216 may also be transformed. The application within window 204 may be continuously running and updating the client area 216 while the transformation is applied in some embodiments.

In another example, a scale function or zoom function within the presentation framework may be used to create a miniature thumbnail image of the window 206. The thumbnail image of the window may be fully functional, but shown in a miniature size when the user wishes the application to run in the background. The presentation framework functionality may be invoked to perform such manipulation to the application window.

Animations may be applied to the windows using the presentation framework. For example, when a window is opened or closed, an animation routine defined in the presentation framework may be used to zoom the window in or out, make the window fade, slide the window off the desktop, or any other motion or smooth transformation may be applied to the entire application window. In some embodiments, animations may be applied to a portion of the window, such as animating the title bar of the window.

Data binding functionality provided through the presentation framework may be used by the desktop window manager. For example, the application window 204 may be bound to the three dimensional transformation. Thus, whenever the application client area 216 is updated by the application, the changes would be automatically transformed through the three dimensional transformation and applied to the user display 200. In another example, a time of day variable may be applied to the color scheme of a window so that the color changes with the time of day. By using data binding, a developer may associate one variable or data element with another. The result is that the changes to one variable will be reflected in the other without complex programming.

Styling and themes may be easily applied to the various windows using the presentation framework. Because many variables are accessible to the designer through the presentation framework, the designer may define a common set of values that may be used across many different windows. For example, a style may include a specific palette of colors that are used for the window borders, button colors, or other elements. A style may also include an animation that is applied to a window in a certain situation. For example, one style may close a window by zooming out until the window disappears, while another style may cause the window to slowly become transparent and fade away for the same action. The presentation framework may provide an enormous range of variables that may define the look and feel and functionality of the desktop window experience. Any of such variables may be configured to be a theme or style element that is applied to several windows or actions on the display to give a consistent user experience.

By using the functionality of a presentation framework designed for applications, the developer of a desktop window manager application may have access to an impressive array of functionality that would only be available through complex coding of low level primitives in a traditional operating system.

In some embodiments, the functionality of the presentation framework may be accessible to the computer user or to a third party to customize the computer desktop. For example, a user-customizable color scheme or presentation of the windows may be possible through the presentation framework. Depending on the functions and extensibility built into the presentation framework, a user or other third party may be able to create elaborate functions that define how the application windows are presented to the user. Such functions may include user defined animations, three dimensional presentations, or any other visual function imaginable.

Further, the presentation framework may be adapted to operate in different environments, such as being able to operate with various graphics accelerators or none at all, present a consistent look and feel regardless of the display pixel density, or other portability features that may be designed into the presentation framework. By leveraging such portability within the desktop window manager, the entire operating system may become more flexible and adaptable and take advantage of some advanced features of different hardware platforms. Such advantages may be realized without recoding the desktop window manager, but by optimizing or adapting the presentation framework.

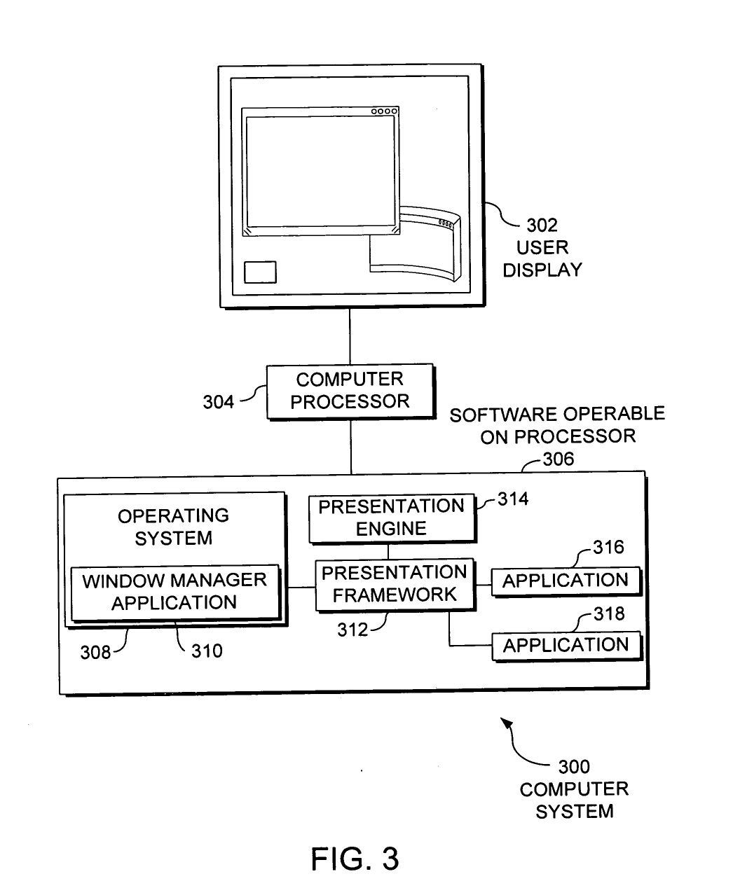

FIG. 3 illustrates an embodiment 300 of a system that uses a presentation framework for generating images on a user display. The user display 302 may have multiple application windows displayed. The images on the user display 302 are created by a computer processor 304 that is operating the software 306. The software architecture includes an operating system 308 that may include a window manager application 310 that calls routines and functionality within a presentation framework 312. A presentation engine 314 may use the presentation framework functionality to generate the images on the user display 302. Additionally, various applications 316 and 318 may call routines and functionality in the presentation framework 312 that are used by the presentation engine 314 to generate the images within the client areas of the windows shown on the user display 302.

The embodiment 300 may be a typical stand alone computer system that may have a hard drive, random access memory, and other components that enables the software 306 to operate on the computer processor 304 to generate the image on the user display 302. In such an embodiment, the software 306 may be stored on a hard disk or other memory storage, a portion of which may be copied onto random access memory that can be quickly accessed and manipulated by the computer processor.

In other embodiments, the user display 302 may be remotely located from the computer processor 304 and/or the storage of the software 306. For example, the user display 302 may be a client device that is located far away from the central computer processor 304. In such an example, a kiosk or computing appliance may be located in a remote location while a majority of the computing operations are performed in a server connected to the user display 302 through a long distance network. Similarly, the storage for the software 306 may be located over a local or wide area network and transferred to the computer processor 304 as required.

In some cases, the computer processor 304 may be a single microprocessor device that handles all activity within the system. In other embodiments, the computer processor 304 may be a combination of processors. For example, a central processor may operate much of the functionality of the applications 316 and 318, while a specialized graphics processor may handle some or all of the functionality of the presentation engine 314. In such cases, the presentation framework 312 and presentation engine 314 may be specifically adapted to use specialized capabilities found within a graphics processor. In some embodiments, two or more computer processors may operate in parallel to increase processing throughput.

The user display 302 may be any device adapted to provide visual output to a user. In a typical embodiment, a computer terminal screen would be used. However, any device capable of visual output may be used, including secondary remote displays, hand held displays connected to the computer processor 304, or any other hardware configuration imaginable.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A graphical user interface system comprising:
a presentation framework having visual presentation functionality accessible to an application, said presentation framework being accessible using a markup language;
a plurality of computer applications operable on an operating system, said applications using said presentation framework to define at least a portion of an application user interface within a client area;
a presentation engine adapted to generate at least a portion of an image on a user display using said presentation framework;
a graphical user interface display application operable in said operating system, said display application using said presentation framework to define at least a portion of at least one displayable window for each of said plurality of computer applications, said at least one displayable window comprising said client area and a non-client area.

2. The graphical user interface system of claim 1 wherein said presentation framework may be accessible using a programming language.

3. The graphical user interface system of claim 1 wherein said graphical user interface display application is adapted to apply animations to said displayable windows using said presentation framework.

4. The graphical user interface system of claim 1 wherein said graphical user interface display application is adapted to apply a style to a plurality of said displayable windows using said presentation framework.

5. The graphical user interface system of claim 1 wherein said graphical user interface display application is adapted to use data binding to said displayable windows using said presentation framework.

6. The graphical user interface system of claim 1 wherein said graphical user interface display application is adapted to apply 3D effects to said displayable windows using said presentation framework.

7. The graphical user interface system of claim 1 wherein said graphical user interface display application is adapted to apply layout parameters to said displayable windows using said presentation framework.

8. A system comprising:
a computer processor;
a user display;
an operating system adapted to operate on said computer processor;
a presentation framework having presentation functionality accessible to an application, said presentation framework being accessible using a markup language;
a plurality of computer applications operable on an operating system, said applications using said presentation framework to define at least a portion of an application user interface within a client area;
a presentation engine adapted to generate at least a portion of an image on said user display using said presentation framework;
a graphical user interface display application operable in said operating system, said display application using said presentation framework to define at least a portion of at least one displayable window for each of said plurality of computer applications, said at least one displayable window comprising said client area and a non-client area.

9. The system of claim 8 wherein said presentation framework may be accessible using a programming language.

10. The system of claim 8 herein said graphical user interface display application is adapted to apply animations to said displayable windows using said presentation framework.

11. The system of claim 8 herein said graphical user interface display application is adapted to apply a style to a plurality of said displayable windows using said presentation framework.

12. The system of claim 8 wherein said graphical user interface display application is adapted to use data binding to said displayable windows using said presentation framework.

13. The system of claim 8 wherein said graphical user interface display application is adapted to apply 3D effects to said displayable windows using said presentation framework.

14. The system of claim 8 wherein said markup language is XAML.

15. A method comprising:
providing a presentation framework adapted to define visual graphical elements that may be displayed on a user display on a computer system, said presentation framework being accessible using a markup language;
making said presentation framework available to applications operable on said computer system;
defining an application window using said presentation framework, said application window having a client area controllable by said applications and a non-client area controllable by a window manager application, at least a portion of said non-client area being defined using said presentation framework; and
displaying said application window on said user display.

16. The method of claim 15 wherein said presentation framework may be further accessible using a programming language.

17. The method of claim 15 further comprising applying animations to said non-client area and said client area of said application window, at least a portion of said animations being defined within said presentation framework.

18. The method of claim 15 further comprising applying a style to said non-client area of said application window, at least a portion of said style being defined within said presentation framework.

19. The method of claim 15 further comprising applying data binding to said non-client area of said application window, at least a portion of said data binding being defined within said presentation framework.

20. The method of claim 15 further comprising applying three dimensional effects to said non-client area and said client area of said application window, at least a portion of said three dimensional effects being defined within said presentation framework.
